(19) United States
(12) Patent Application Publication
(10) Pub. No.: US 2004/0133518 A1
(43) Pub. Date: Jul. 8, 2004

(54) Method and system for enhancing local media content with remote auxiliary content

(76) Inventor: Steven Dryall, Toronto (CA)

Correspondence Address: GOWLING LAFLEUR HENDERSON LLP, COMMERCE COURT WEST, SUITE 4900, TORONTO, ON, M5L 1J3, CA

(21) Appl. No.: 10/337,731

(22) Filed: Jan. 8, 2003

(51) Int. Cl. G06F 17/60

(52) U.S. Cl. 705/50

(57) ABSTRACT

A computer-based method of enhancing primary media content at a computer-readable storage medium local to a network terminal begins by retrieving from the storage medium a reference to a remote content server. The terminal then transmits over a network to the remote content server a request for auxiliary content, and downloads the requested auxiliary content over the network to the terminal. The downloaded auxiliary content is associated with the primary media content and comprises one of an electronic ticket, an event schedule and auxiliary media content. The terminal also receives configuration data defining a presentation format for the auxiliary content, and renders the downloaded content in accordance with the defined presentation format.

### FIELD OF THE INVENTION

The present invention relates to a mechanism for enhancing the delivery of media content to computer users. In particular, the present invention relates to a method and system for enhancing the media content stored on a computer-readable storage medium.

### BACKGROUND OF THE INVENTION

Computer-readable removable storage media are popular mechanisms for providing end-users with media content. For instance, CDs and DVDs, often carry audio recordings and motion pictures which can be presented either on a personal computer or a dedicated player. More recently, computer software has been developed to enhance the media presentation.

For instance, RealPlayer™ offers audio player software which allows end-users to play audio CDs on a personal computer. The software enhances the audio presentation experience by allowing the end-user to digitize and store the audio tracks locally on the personal computer. The software also allows the end-user to store the artist name, track title and genre of the audio CD locally by querying a remote server for this additional information. However, it is often desirable to provide end-users with non-generic content which is tailored to user preferences and interests.

Sony (EP 1 235 178) has attempted to meet this need by providing users of its PlayStation™ game console with auxiliary advertising content associated with primary multimedia content, such as streaming audio, streaming video and game data. Advertisers distribute CD-ROMs which include a unique identifier, network communication software, and auxiliary advertising content. When a user inserts the CD-ROM into the game console, the communication software initiates communication with a remote server over the Internet, and then provides the server with the unique identifier of the CD-ROM. From the unique identifier, the remote server determines if the user has previously provided the server with user preference data and, if so, transmits the user preference data to the game console together with the primary multimedia content. While the primary content is downloading to the game console, the game console selects auxiliary advertising content from the CD-ROM using the user preference data, and then presents the selected auxiliary content to the user.

This approach has the advantage of allowing advertisers to associate their advertisements with popular primary content, while at the same time providing end-users with an enriched advertising experience which is typically not possible over a wide area network. Also, advertisers are able to tailor their advertising content by analyzing the user preference data. However, since the advertising content is stored on the CD-ROM, advertisers are precluded from using the user preference data to dynamically modify their advertising content.

Therefore, there remains a need for an improved mechanism for enhancing the media presentation of media content stored on a local removable storage medium.

### SUMMARY OF THE INVENTION

According to the present invention, there is provided a method and system which downloads to computer users auxiliary content which is dynamically associated with primary media content stored on a local computer-readable storage medium.

In accordance with a first aspect of the present invention, there is provided a computer-based method of enhancing local media content. The method involves the steps of:

retrieving from a local computer-readable storage medium a reference to a remote content server, the local storage medium including primary media content;

transmitting over a network to the remote content server a request for auxiliary content; and

downloading the requested auxiliary content over the network, the downloaded auxiliary content being associated with the primary media content and comprising one of an electronic ticket, an event schedule and auxiliary media content.

In accordance with the first aspect of the invention, there is also provided a computer-readable medium carrying processing instructions for a computer which when executed by the computer cause the computer to perform the steps of:

retrieving from a local computer-readable storage medium a reference to a remote content server, the local storage medium including primary media content;

transmitting over a network to the remote content server a request for auxiliary content; and

downloading the requested auxiliary content over the network, the downloaded auxiliary content being associated with the primary media content and comprising one of an electronic ticket, an event schedule and auxiliary media content.

In accordance with a second aspect of the present invention, there is provided a computer-based method of enhancing local media content. The method involves the steps of:

from a network terminal transmitting over a network to a remote content server a request for auxiliary content, the network terminal having local access to primary media content;

at the network terminal receiving over the network the requested auxiliary content, and configuration data defining a presentation format for the received auxiliary content, the received auxiliary content being associated with the primary media content and comprising one of an electronic ticket, an event schedule and auxiliary media content; and

rendering the received auxiliary content at the network terminal in accordance with the defined presentation format.

In accordance with the second aspect of the invention, there is also provided a computer-readable medium carrying processing instructions for a computer which when executed by the computer cause the computer to perform the steps of:

from a network terminal transmitting over a network to a remote content server a request for auxiliary content, the network terminal having local access to primary media content;

at the network terminal receiving over the network the requested auxiliary content, and configuration data defining a presentation format for the received auxiliary content, the received auxiliary content being associated with the primary media content and comprising one of an electronic ticket, an event schedule and auxiliary media content; and

rendering the received auxiliary content at the network terminal in accordance with the defined presentation format.

In accordance with a third aspect of the present invention, there is also provided a removable computer readable medium comprising:

a media partition including primary media content, the primary media content comprising at least one of an audio presentation, a video presentation and a multimedia presentation; and

a program partition including processing instructions for a computer which when executed by the computer cause the computer to:

transmit over a network to a remote content server a request for auxiliary content associated with the primary media content;

receive over the network the requested auxiliary content, and configuration data defining a presentation format for the received auxiliary content, the received auxiliary content comprising one of an electronic ticket, an event schedule and auxiliary media content; and

render the received auxiliary content in accordance with the defined presentation format.

In accordance with a fourth aspect of the present invention, there is provided a computer-based method of providing enhanced local media content. The method involves the steps of:

at a content server receiving from a network client a request for content auxiliary to primary media content, the primary media content being stored locally to the network client;

transmitting to the network client configuration data defining a presentation format for rendering of the requested auxiliary content by the network client; and

facilitating downloading of the requested auxiliary content over the network to the network client in a format for retention by the network client, the downloaded auxiliary content being associated with the primary media content and comprising one of an electronic ticket, an event schedule and auxiliary media content.

In accordance with the fourth aspect of the invention, there is also provided an auxiliary content management system comprising:

a database including auxiliary content, the auxiliary content comprising one of an electronic ticket, an event schedule and auxiliary media content and being stored in a format for retention by a network client; and

a database manager in communication with the database for downloading the auxiliary content to the network client, the downloaded auxiliary content being associated with primary media content local to the network client.

In accordance with a fifth aspect of the present invention, there is provided a computer-based method of enhancing local media content. The method involves the steps of:

loading from a local computer-readable storage medium into a memory of a network terminal a computer software module carrying processing instructions for the network terminal and a reference to a remote content server, the local storage medium including primary media content;

with the processing instructions transmitting over a network to the remote content server a reference to the primary media content;

at the network terminal receiving over the network from the remote content server configuration data defining a presentation format for a virtual terminal, and a reference to an auxiliary content database;

with the processing instructions rendering the virtual terminal at the network terminal;

downloading from the auxiliary content database the requested auxiliary content to the network terminal in a format for retention on the network terminal, the downloaded auxiliary content being associated with the primary media content and comprising one of an electronic ticket, an event schedule and auxiliary media content; and

with the processing instructions rendering the received auxiliary content on the virtual terminal.

In accordance with the fifth aspect of the invention, there is also provided a computer-readable medium comprising:

a media partition including primary media content, the primary media content comprising at least one of an audio presentation, a video presentation and a multimedia presentation; and

a program partition including a computer software module carrying processing instructions for a computer and a reference to a remote content server, the processing instructions when executed by the computer causing the computer to:

transmit over a network to the remote content server a reference to the primary media content;

at the computer receive over the network from the remote content server configuration data defining a presentation format for a virtual terminal, and a reference to an auxiliary content database;

render the virtual terminal at the network terminal;

download from the auxiliary content database the requested auxiliary content to the network terminal in a format for retention on the network terminal, the downloaded auxiliary content being associated with the primary media content and comprising one of an electronic ticket, an event schedule and auxiliary media content; and

render the received auxiliary content on the virtual terminal.

### BRIEF DESCRIPTION OF THE DRAWINGS

The present invention will now be described, by way of example only, with reference to the accompanying drawings in the which:

FIG. 1 is a schematic view of the auxiliary content delivery system, according to the present invention, depicting the auxiliary content database, the database manager, the content server and the network terminal;

FIG. 2 is a schematic view of the network terminal depicted in FIG. 1;

FIGS. 3a and 3b together comprise a flowchart that depicts the method of enhancing local media content; and

FIG. 4 is a screenshot of a sample virtual terminal rendered on the network terminal.

### DETAILED DESCRIPTION OF THE PREFERRED EMBODIMENT

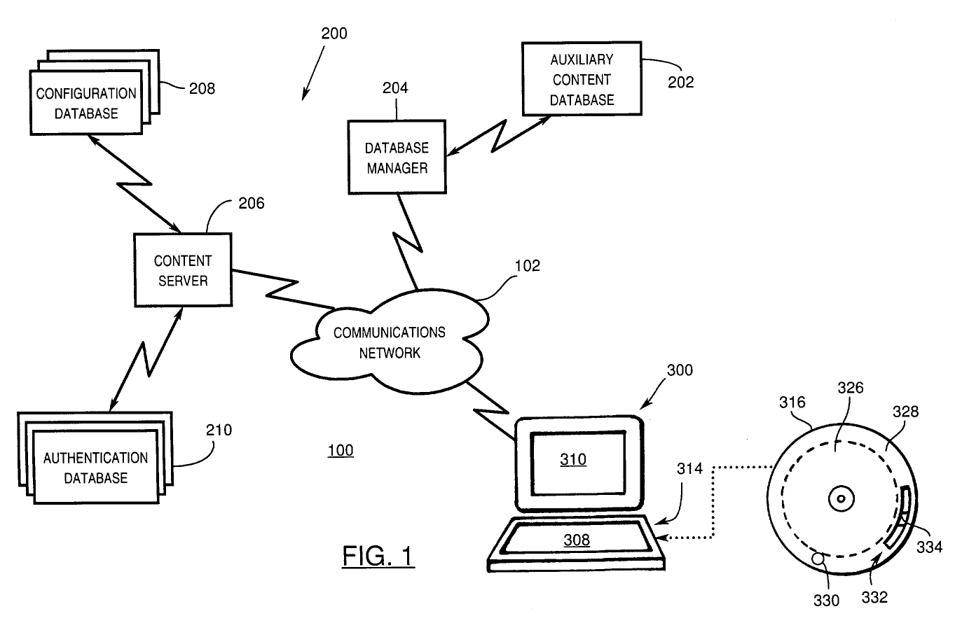

Turning to FIG. 1, an auxiliary content delivery system, denoted generally as 100, is shown comprising an auxiliary content management system 200, a network terminal 300, and a communications network 102 interconnecting the auxiliary content management system 200 and the network terminal 300. Although the auxiliary content delivery system 100 is shown comprising only a single auxiliary content management system 200 and a single network terminal 300, it should be understood that the auxiliary content delivery system 100 will typically include several auxiliary content management systems 200 and several single network terminals 300. Preferably, the communications network 102 comprises a wide area wired network, such as the Internet, however the communications network 102 may instead comprise a local area network, a wireless network, or a hybrid of wired networks and wireless networks.

The auxiliary content delivery system 200 comprises an auxiliary content database 202, and a database manager 204 in communication with the auxiliary content database 202. In addition, the auxiliary content delivery system 200 includes a content server 206 which serves to facilitate downloading of auxiliary content from the auxiliary content database 202 to the network terminals 300. Although the auxiliary content delivery system 200 is shown comprising a distinct database manager 204 and a distinct content server 206, the functions of the database manager 204 and the content server 206 may also be integrated into a single computer server.

As will be described, the network terminals 300 have access to primary media content that is stored locally to the network terminals 300. The auxiliary content is associated with the primary media content, and supplements or enhances the primary media content stored locally to the network terminals 300. Typically, the primary media content is stored on a removable computer-readable medium, such as a CD-ROM, a DVD-ROM, an electronic memory cartridge, a floppy disk, or a removable hard-drive. Alternately, however, the primary media content may be stored on a local fixed hard drive, or on a magnetic or optical drive array maintained locally to the network terminals 300 and accessible by the network terminals 300. Other forms of storage media will be apparent to those of ordinary skill, and are intended to be encompassed by the present invention.

The auxiliary content database 202 includes the aforementioned auxiliary content. Preferably, the auxiliary content is stored in the auxiliary content database 202 in a format which allows the auxiliary content to be saved on the network terminal 300 for subsequent playback, if desired. Typically, the auxiliary content comprises electronic tickets, event schedules and/or auxiliary media content, although the invention is not limited to these enumerated forms of auxiliary content. The electronic tickets can be redeemed by users of the network terminals 300 for discounts on the purchase of CDs, DVDs, concert tickets or other items associated with the primary media content. For instance, if the primary media content is a music CD, the electronic ticket could provide a discount on the purchase of another music CD by the same artist or sound studio, or the next concert given by the same artist. If the primary media content is a video DVD, the electronic ticket could provide a discount on the purchase of another DVD by the same motion picture studio. If the primary media content is a document-based publication, such as an electronic magazine, an electronic newspaper, or a photo album, the electronic ticket could provide a discount on the purchase of subscription for the publication. Other types of electronic tickets will be apparent to those of ordinary skill, and are intended to be encompassed by the present invention.

Event schedules identify one or more event dates associated with the primary media content. For instance, if the primary media content is a music CD, the event schedule could identify the date of the next music CD released by the same artist, or the date and location of the next concert (ie a concert notification) given by the same artist. Alternately, the event schedule could identify a number of such dates. If the primary media content is a video DVD (eg. a motion picture), the event schedule could identify the release date of another motion picture by the same motion picture studio or the same director/producer, or featuring the actor(s) featured in the video DVD. If the primary media content is a video DVD of an instalment in a trilogy of movies, the event schedule could identify the release date of the instalment in the trilogy. Other forms of event schedules will be apparent to those of ordinary skill, and are intended to be encompassed by the present invention.

Auxiliary media content comprises media content that was not included with the primary media content. For instance, if the primary media content is a music CD, the auxiliary media content could comprise an audio performance (ie. a bonus track) by the same artist which was excluded from the issued CD; or a music video by the artist. If the primary media content is a video DVD, the auxiliary media content could comprise, for example, a video trailer, an interview, still photographs, or a multi-media performance that was not included with the issued DVD. If the primary media content is a photo album, the auxiliary media content could comprise, for example, photo updates or print ordering information.

The primary and auxiliary media content is not limited to the aforementioned content forms. For instance, the primary media content can be a software-based media, such as software applications or computer games. If the primary media content is computer software, the associated auxiliary media content can comprise version updates, additional templates or add-ons, or plug-ins not included with the original software release. If the primary media content is a computer game, the associated auxiliary media content can provide the user of the game with additional skill levels, adventures, characters or sound tracks.

As discussed above, the primary media content can also comprise document-based content, such as electronic magazines, electronic calendars, electronic greeting cards, electronic newspapers, electronic catalogues, electronic books, electronic user manuals, or electronic course materials. If the primary media content is an electronic magazine, the associated auxiliary media content can comprise additional articles and/or photos. If the primary media content is an electronic calendar, the associated auxiliary media content can comprise daily, weekly or monthly artwork updates, or holiday notifications. If the primary media content is an electronic greeting card, the associated auxiliary media content can comprise a new message, a new greeting card cover, animation, music, narration and/or video not included with the original greeting card.

If the primary media content is an electronic newspaper, the associated auxiliary media content can comprise late breaking news or advertisements not included with the original newspaper. If the primary media content is an electronic catalogue, the associated auxiliary media content can provide the reader of the catalogue with product availability or shipping information, a list/description of new products not included with the original electronic catalogue, or a notification of specials on identified products. If the primary media content is an electronic book, the associated auxiliary media content can comprise additional chapters not included with the original book, replacement chapters to change the outcome of the story described in the book, and/or biographical and bibliographical information. If the primary media content is a technical user manual, the associated auxiliary media content can comprise update chapters for the manual, or a description of new models not covered by the manual. If the primary media content comprises electronic course materials, the associated auxiliary media content can comprise additional lessons, exercises, questions and/or answers not included with the original course materials.

Also, as discussed above, the primary media content is not limited to forms provided on optical-based media, such as CDs or DVDs, but can also be provided on electronic memory cartridges, such as a SmartCard™. In this latter case, the primary media content can comprise, for example, a security pass or a trading card. If the primary media content is a security pass, the associated auxiliary media content can comprise, for instance, messages (eg. policy updates, personnel updates, e-mail messages) for the bearer of the security pass. If the primary media content is a trading card associated, for instance, with a baseball player, the associated auxiliary media content can comprise additional statistical (eg. batting average, earned run average) or biographical information associated with the individual identified on the trading card. Further, the auxiliary media content associated with the trading card can provide the owner of the card with non-player-related information, such as new card previews, and promotional notifications.

Other forms of primary and auxiliary media content will be apparent to those of ordinary skill, such as combinations of the above-identified content forms, and are intended to be encompassed by the present invention.

Preferably, the database manager 204 is implemented as a FTP computer server having a network interface to the communications network 102. The database manager 204 is configured to allow the network terminals 300 to download the auxiliary content from the auxiliary content database 202 to the network terminals 300.

Preferably, the content server 206 is provided as a XML computer server having a network interface to the communications network 102. The content server 206 is in communication with a configuration database 208, and an authentication database 210. The configuration database 208 includes media identifiers, and associated configuration data that data defines the audio and/or visual presentation format for the rendering of the auxiliary content at the network terminals 300. In the event that the presentation format comprises a video presentation, preferably the configuration data is provided in XML The content server 206 is configured to provide the configuration data with the network terminals 300 when the network terminals 300 make a request of the content server 206 for auxiliary content.

The authentication database 210 includes the same media identifiers, and network addresses for database managers 204. As will be explained, the local computer-readable medium includes a media ID that identifies the associated primary media content. The network terminals 300 transmit the media ID of their associated local computer-readable medium to the content server 206 when the network terminals 300 make a request for the auxiliary content. The content server 206 is configured to verify the authenticity of the local computer-readable medium by querying the authentication database 210 with the received media ID. If the media ID is validated, the content server 206 provides the requesting network terminal 300 with the network address of the database manager 204 whose auxiliary content database 202 has the auxiliary content associated with the primary media content. In this manner, the network terminal 300 will always be directed to the appropriate database manager 204, even if the network address of the database manager 204 is changed.

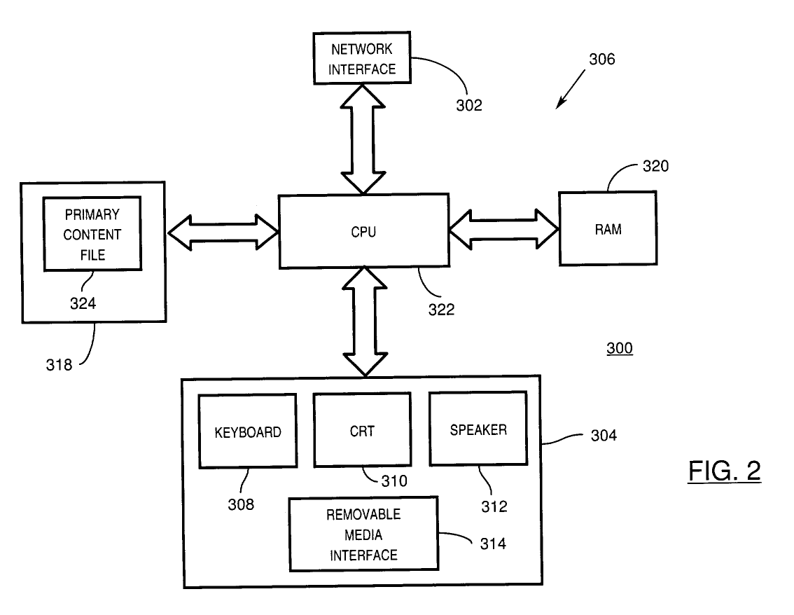

The network terminals 300 are typically implemented as personal computers, or wireless-enabled personal data assistants, although the present invention is not limited to these forms of network terminals 300. An exemplary network terminal 300 is depicted in FIG. 2. As shown, the network terminal 300 comprises a network interface 302, an I/O sub-system 304, and a data processing system 306 in communication with the network interface 302 and the I/O sub-system 304. The network interface 302 interfaces the network terminal 300 to the communications network 102. In the event that the communications network 102 is a wired network, the network interface 302 comprises a wired interface, such as a PSTN modem or a network interface card (such as an Ethernet card). Alternately, in the event that the communications network 102 is a wireless network, the network interface 302 comprises a wireless interface, such as an RF modem or an infrared communications port.

The I/O sub-system 304 includes a data entry device 308, a display device 310, an audio device 312, and a removable media interface 314. The data entry device 308 allows the user of the network terminal 300 to enter data into the data processing system 306, and typically comprises a keyboard, a mouse or a writing tablet. The display device 310 visually renders information to the user of the network terminal 300. Typically, the display device 310 comprises a CRT display, a LCD panel or a plasma membrane display. The audio device 312 audibly renders information to the user of the network terminal 300. Typically, the audio device 312 comprises a speaker or a earphone or headset.

The removable media interface 314 provides the network terminal 300 with access to information stored on the removable computer-readable medium 316. As discussed above, typically the removable computer-readable medium 316 comprises a CD-ROM, a DVD-ROM, an electronic memory cartridge, a floppy disk or a removable hard-drive. Consequently, typically the removable media interface 314 comprises a CD-ROM drive, a DVD drive, a PCMCIA slot, a floppy disk drive, or a removable hard-drive interface slot.

The data processing system 306 comprises a non-volatile memory (ROM) 318, a volatile electronic memory (RAM) 320, and a central processing unit (CPU) 322 in communication with the ROM 318 and the RAM 320. The ROM 318 typically comprises a magnetic hard-drive or an EPROM electronic memory. The ROM 318 includes processing instructions for the CPU 322 which, when loaded into the RAM 320, define an operating system which allows the data processing system 306 to transmit and receive data over the network interface 302 and the I/O sub-system 304. Typically, the operating system comprises a MacOS™ operating system, a Microsoft Windows™ operating system, or a Linux™ operating system.

Preferably, the removable computer-readable medium 316 is write-protected and is accessible by the data processing system 306 via the removable media interface 314. Further, preferably, the primary media content is stored on the write-protected computer-readable medium 316. However, the primary media content may also be stored on a magnetic or optical drive array maintained locally to the network terminals 300 and accessible by the network terminals 300 via the network interface 302, or as a computer-readable content file 324 in the ROM 314.

As shown diagrammatically in FIG. 1, the removable computer-readable medium 316 (or the computer-readable content file 324) includes a computer-readable media partition 326 and a computer-readable program partition 328. The media partition 326 includes the primary media content. Typically, the primary media content comprises an audio presentation (eg. music, sound clips), a visual presentation (eg. a motion picture, a slide-show, one or more still images, or text), or a multimedia presentation (eg. a computer game, or an electronic encyclopaedia).

The program partition 328 includes a media ID 330 that identifies the primary media content, and a computer software module 332 comprising computer software processing instructions that the network terminal 300 uses to download auxiliary content associated with the primary media content. Preferably, the computer software processing instructions of the computer software module 332 are arranged as a number of software objects or modules, each implemented in a format for execution on one of the popular operating systems (eg. a MacOS™, Microsoft Windows™, or Linux™). Alternately, the computer software processing instructions of the computer software module 332 could comprise a single platform-independent object or module, written for instance using Java™ or JavaScript™, to allow the data processing system 306 to download the auxiliary content regardless of the type of operating system implemented on the data processing system 306.

In addition to the computer software, the computer software module 332 includes a reference 334 to the location of the content server 206. Typically the reference 334 comprises the URL of the content server 206, a port number through which communications with the content server 206 will be recognized, and a directory path to the configuration database 208 that includes the requisite configuration data. As will be apparent, although the reference 334 preferably comprises the URL of the content server 206, the reference 334 could instead comprise the network (eg. IP) address of the content server 206.

In the event that the primary media content is provided on the removable computer-readable medium 316, preferably the removable computer-readable medium 316 is configured such that the primary media content can be accessed via a non-computer-based reader, without interference by the program partition 328. For example, if the primary media content is provided on a music CD, preferably the primary media content can be accessed on a conventional or portable CD player, without the program partition 328 interfering with the performance of the primary media content. On the other hand, preferably the program partition 328 is configured such that when the removable computer-readable medium 316 is accessed by the I/O sub-system 304, the computer software module 332 is automatically loaded by the operating system into the RAM 320.

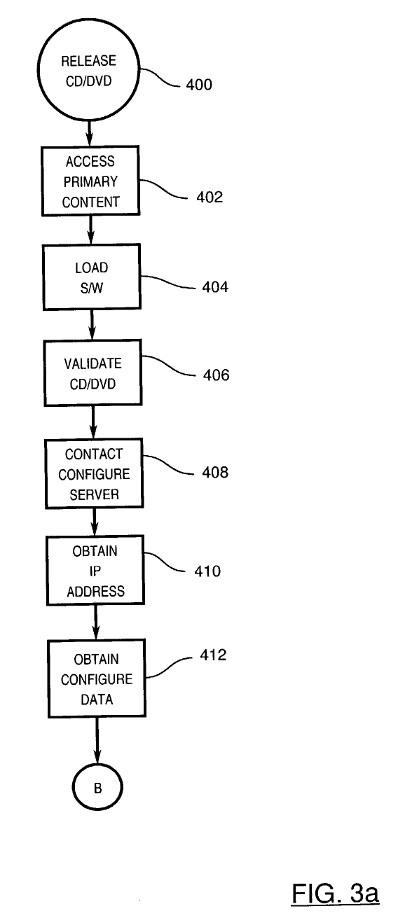

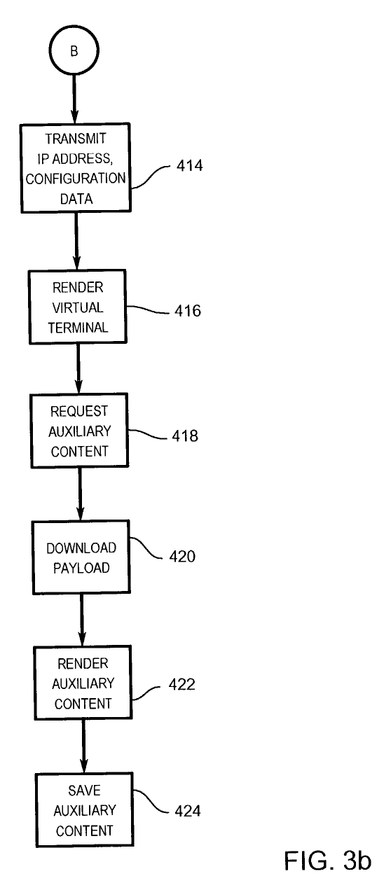

The method by which the computer terminal 300 downloads the auxiliary content over the communications network 102 will now be described with reference to FIG. 3. Initially, at step 400, a sound studio or a motion picture studio will release primary media content. Typically, the primary media content will be released either on a removable computer-readable medium 316, or as a computer-readable content file 324 available from a file server for a fee over the communications network 102. At step 402, the user makes the primary media content accessible by the network terminal 300 by inserting the removable computer-readable medium 316 into the removable media interface 314, or by downloading the computer-readable content file 324 from the appropriate file server to the ROM 318 or a local drive array.

The network terminal 300 then accesses the removable computer-readable medium 316 (or the computer-readable content file 324), and retrieves therefrom the computer software module 332 appropriate for the operating system installed on the network terminal 300. The network terminal 300 loads the computer software module 332 into the RAM 320, at step 404, and begins to execute the computer software processing instructions contained therein.

At step 406, the computer software module 332 causes the network terminal 300 to validate the authenticity of the primary media content. In the preferred implementation where the primary media content is stored on the write-protected removable computer-readable medium 316, preferably the computer software module 332 performs the validation by performing a write-test on the computer-readable medium 316, thereby ensuring that the primary media content and/or the computer software module 332 were not copied from the original computer-readable medium 316 issued by the studio. Other mechanisms for performing a validation of the computer-readable medium 316 will be apparent, and are intended to fall within the scope of the present invention.

If the validation step 406 passes, the computer software module 332 invokes a software routine in the operating system of the network terminal 300 which causes the network terminal 300 to attempt to open a communications channel (over the communications network 102) with the content server 206 at the network address identified by the reference 334. Preferably, the communications channel is encrypted to limit unauthorized access to auxiliary content.

If the network terminal 300 is unable to open the communications channel, the computer software module 332 provides the user of the network terminal with an error message via the I/O sub-system 304. However, if the network terminal 300 is able to open the communications channel, at step 408, the computer software module 332 makes a request of the content server 206 for auxiliary content by transmitting the media ID 330 over the communications channel to the content server 206. Upon receipt of the media ID 330, the content server 206 queries the authentication database 210 to determine whether the received media ID 330 is valid.

If the content server 206 locates the media ID 330 in the authentication database 210, the media ID 330 is valid, and at step 410, the content server 206 extracts from the authentication database 210 the network address associated with the media ID 330. As discussed above, the retrieved network address is the network address of the database manager 204 whose auxiliary content database 202 has the auxiliary content associated with the primary media content.

In addition, the content server 206 queries the configuration database 208 with the received media ID 330 for the configuration data associated with the media ID 330 and, at step 412, extracts the configuration data associated with the media ID 330. As discussed above, the configuration data defines the audio and/or visual presentation format for the rendering of the auxiliary content at the network terminals 300.

The content server 206 then facilitates downloading of auxiliary content from the auxiliary content database 202, at step 414, by transmitting the retrieved network address and the retrieved configuration data to the network terminal 300. Typically, the content server 206 transmits the retrieved network address and the retrieved configuration data to the network terminal 300 using hypertext transport protocol.

In the event that the received configuration data dictates that the presentation format should be a visual presentation, typically the configuration data specifies a number of drawing methods (eg. draw text, draw line, draw oval, draw rectangle) that define the appearance of a virtual terminal upon which the auxiliary content should be rendered. Additionally, the configuration data specifies the functionality of any graphic items rendered as functional components (eg control panel, status indicators) of the virtual terminal. In this variation, preferably the computer software module 332 includes a number of drawing methods, and renders the virtual terminal using the methods specified in the configuration data, at step 416. Optionally, the configuration data can include a link to a background image file on the content server 206. In this variation, preferably the computer software module 332 renders the virtual terminal first, and then begins downloading the image file from the content server 206, so that the virtual terminal remains functional while the image is being downloaded.

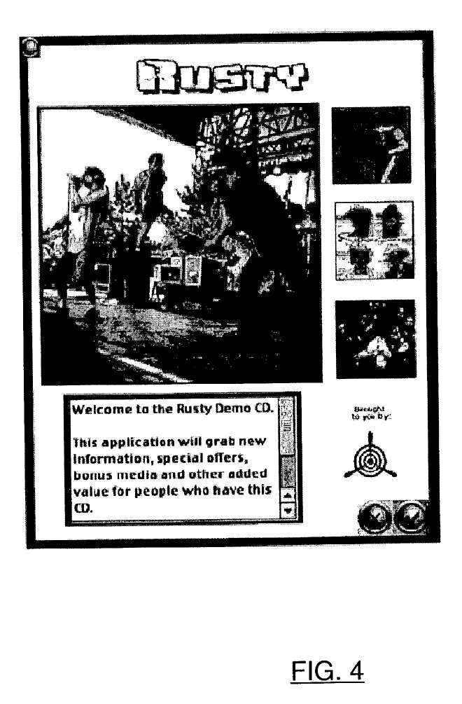

A sample virtual terminal is depicted in FIG. 4. The lower right corner of the virtual terminal includes a control panel that allows the user of the network terminal 300 to initiate or cancel the download of auxiliary content (described below). The upper left corner of the virtual terminal includes a status indicator whose color indicates the completion status of the auxiliary content download. Although not depicted, the virtual terminal can include one or more links to other computer servers, such as the publisher's web site.

After the network address and the configuration data is received by the computer software module 332 (and the virtual terminal is rendered, if required), the computer software module 332 causes the communications channel with the content server 206 to be closed. Then, the computer software module 332 invokes a software routine in the operating system of the network terminal 300 which causes the network terminal 300 to attempt to open a communications channel (over the communications network 102) with the database manager 204 at the network address received from the content server 206.

If the network terminal 300 is unable to open the communications channel, the computer software module 332 provides the user of the network terminal with an error message via the I/O sub-system 304. However, if the network terminal 300 is able to open the communications channel, at step 418, the computer software module 332 issues a request to the database manager 204 for auxiliary content.

The database manager 204 queries the associated auxiliary content database 202 for the auxiliary content and, then creates a compressed data package (“payload”) that includes the requested auxiliary content. Preferably, the database manager 204 creates the payload by incorporating the auxiliary content into a Macintosh resource file, and then compresses and encrypts the resource file. At step 420, the database manager 204 transmits the payload to the computer software module 332. Preferably, the computer software module 332 downloads the payload from the database manager 204 using file transfer protocol.

Upon receipt of the payload, the computer software module 332 decrypts and decompresses the payload, and extracts the auxiliary content from the Macintosh resource file. The computer software module 332 then renders the received auxiliary content, at step 422, in accordance with the presentation format defined by the received configuration data. After the auxiliary content is rendered, at step 424 preferably the computer software module 332 provides the user of the network terminal 300 with the option of saving the auxiliary content to the ROM 314, or some other specified network resource. With the exception of any auxiliary content so saved, typically the computer software module 332 does not leave any residual files on the ROM 314.

The present invention has the unique advantage that, since the auxiliary content is stored in the auxiliary content database 202, the auxiliary content presented to users can be dynamically updated by the publisher simply by installing new auxiliary content in the auxiliary content database 202. Additionally, the location of the auxiliary content database 202 can be changed without impacting auxiliary content download, by updating the network address for the associated media identifier in the authentication database 210. Further, the presentation format of the auxiliary content can be dynamically updated by the publisher, simply by installing new configuration data in the configuration database 208.

The present invention is defined by the claims appended hereto, with the foregoing description identifying a preferred embodiment of the invention. Those of ordinary skill may envisage certain modifications to the foregoing description which, although described or explicitly suggested herein, do not depart from the scope of the invention, as defined by the appended claims.

We claim:

1. A computer-based method of enhancing local media content, comprising the steps of:
at a network terminal retrieving from a local computer-readable storage medium a reference to a remote content server, the local storage medium including primary media content;
transmitting over a network to the remote content server a request for auxiliary content; and
downloading the requested auxiliary content over the network to the network terminal, the downloaded auxiliary content being associated with the primary media content and comprising one of an electronic ticket, an event schedule and auxiliary media content.

2. The method according to claim 1, wherein the local storage medium includes a media identifier associated with the primary media content, the retrieving step comprises loading into a memory of the network terminal a computer program stored on the local storage medium, the computer program including the reference to the remote content server, and the transmitting step comprises the steps of with the computer program (i) validating an authenticity of the storage medium, and (ii) forwarding the media identifier to the remote content server in accordance with the validation step.

3. The method according to claim 2, wherein the forwarding step comprises the steps of with the computer program opening an encrypted communications channel with the remote content server, and forwarding the media identifier to the remote content server over the encrypted communications channel.

4. The method according to claim 3, wherein the downloading step comprises the steps of receiving from the remote content server configuration data defining a presentation format for the requested auxiliary content, and rendering the downloaded auxiliary content at the network terminal in accordance with the defined presentation format.

5. The method according to claim 4, wherein the downloaded content is received in a format for storage at the network terminal.

6. A computer-readable medium carrying processing instructions for a computer which when executed by the computer cause the computer to perform the steps of:
retrieving from a local computer-readable storage medium a reference to a remote content server, the local storage medium including primary media content;
transmitting over a network to the remote content server a request for auxiliary content; and
downloading the requested auxiliary content over the network to the computer, the downloaded auxiliary content being associated with the primary media content and comprising one of an electronic ticket, an event schedule and auxiliary media content.

7. The computer-readable medium according to claim 6, wherein the local storage medium includes a media identifier associated with the primary media content, the retrieving step comprises loading into a memory of the network terminal a computer program stored on the local storage medium, the computer program including the reference to the remote content server, and the transmitting step comprises the steps of with the computer program (i) validating an authenticity of the storage medium, and (ii) forwarding the media identifier to the remote content server in accordance with the validation step.

8. The computer-readable medium according to claim 7, wherein the forwarding step comprises the steps of with the computer program opening an encrypted communications channel with the remote content server, and sending the media identifier to the remote content server over the encrypted communications channel.

9. The computer-readable medium according to claim 8, wherein the downloading step comprises the steps of receiving from the remote content server configuration data defining a presentation format for the requested auxiliary content, and rendering the downloaded auxiliary content at the network terminal in accordance with the defined presentation format.

10. The computer-readable medium according to claim 9, wherein the downloaded content is received in a format for storage at the computer.

11. A computer-based method of enhancing local media content, comprising the steps of:
from a network terminal transmitting over a network to a remote content server a request for auxiliary content, the network terminal having local access to primary media content;
at the network terminal receiving over the network the requested auxiliary content, and configuration data defining a presentation format for the received auxiliary content, the received auxiliary content being associated with the primary media content and comprising one of an electronic ticket, an event schedule and auxiliary media content; and
rendering the received auxiliary content at the network terminal in accordance with the defined presentation format.

12. The method according to claim 11, wherein the primary media content is stored on a local storage medium, the local storage medium including a media identifier associated with the primary media content, the transmitting step comprises the steps of loading into a memory of the network terminal a computer program stored on the local storage medium, and with the computer program (i) validating an authenticity of the storage medium, and (ii) forwarding the media identifier to the remote content server in accordance with the validation step.

13. The method according to claim 12, wherein the forwarding step comprises the steps of with the computer program opening an encrypted communications channel with the remote content server, and sending the media identifier to the remote content server over the encrypted communications channel.

14. The method according to claim 13, wherein the computer program includes a reference to the remote content server, and the opening step comprises opening the communications channel with the remote content server associated with the reference.

15. The method according to claim 14, wherein the receiving step comprises downloading the auxiliary content in a format for storage at the network terminal.

16. A computer-readable medium carrying processing instructions for a computer which when executed by the computer cause the computer to perform the steps of:
from the computer transmitting over a network to a remote content server a request for auxiliary content, the computer having local access to primary media content;
at the computer receiving over the network the requested auxiliary content, and configuration data defining a presentation format for the received auxiliary content, the received auxiliary content being associated with the primary media content and comprising one of an electronic ticket, an event schedule and auxiliary media content; and
rendering the received auxiliary content at the computer in accordance with the defined presentation format.

17. The computer-readable medium according to claim 16, wherein the primary media content is stored on a local storage medium, the local storage medium including a media identifier associated with the primary media content, the transmitting step comprises the steps of loading into a memory of the computer a computer program stored on the local storage medium, and with the computer program (i) validating an authenticity of the storage medium, and (ii) forwarding the media identifier to the remote content server in accordance with the validation step.

18. The computer-readable medium according to claim 17, wherein the forwarding step comprises the steps of with the computer program opening an encrypted communications channel with the remote content server, and sending the media identifier to the remote content server over the encrypted communications channel.

19. The computer-readable medium according to claim 18, wherein the computer program includes a reference to the remote content server, and the opening step comprises opening the communications channel with the remote content server associated with the reference.

20. The computer-readable medium according to claim 19, wherein the receiving step comprises downloading the auxiliary content in a format for storage at the computer.

21. A removable computer-readable medium comprising:
a media partition including primary media content, the primary media content comprising at least one of an audio presentation, a video presentation and a multimedia presentation; and
a program partition including processing instructions for a computer which when executed by the computer cause the computer to:
transmit over a network to a remote content server a request for auxiliary content associated with the primary media content;
receive over the network the requested auxiliary content, and configuration data defining a presentation format for the received auxiliary content, the received auxiliary content comprising one of an electronic ticket, an event schedule and auxiliary media content; and
render the received auxiliary content in accordance with the defined presentation format.

22. The removable computer-readable medium according to claim 21, wherein the program partition includes a media identifier associated with the primary media content, the transmitting step comprises the steps of loading the processing instructions into a memory of the computer, and in accordance with the processing instructions (i) validating an authenticity of the computer-readable medium, and (ii) forwarding the media identifier to the remote content server in accordance with the validation step.

23. The removable computer-readable medium according to claim 22, wherein the forwarding step comprises the steps of opening an encrypted communications channel with the remote content server, and sending the media identifier to the remote content server over the encrypted communications channel.

24. The removable computer-readable medium according to claim 23, wherein the program partition includes a reference to the remote content server, and the opening step comprises opening the communications channel with the remote content server associated with the reference.

25. The removable computer-readable medium according to claim 24, wherein the receiving step comprises downloading the auxiliary content in a format for storage at the computer.

26. A computer-based method of providing enhanced local media content, comprising the steps of:
at a content server receiving from a network client a request for content auxiliary to primary media content, the primary media content being stored locally to the network client;
transmitting to the network client configuration data defining a presentation format for rendering of the requested auxiliary content by the network client; and
facilitating downloading of the requested auxiliary content over the network to the network client in a format for retention by the network client, the downloaded auxiliary content being associated with the primary media content and comprising one of an electronic ticket, an event schedule and auxiliary media content.

27. A computer-based method of enhancing local media content, comprising the steps of:
loading from a local computer-readable storage medium into a memory of a network terminal a computer software module carrying processing instructions for the network terminal, and a reference to a remote content server, the local storage medium including primary media content;
with the processing instructions transmitting over a network to the remote content server a reference to the primary media content;
at the network terminal receiving over the network from the remote content server configuration data defining a presentation format for a virtual terminal, and a reference to an auxiliary content database;
with the processing instructions rendering the virtual terminal at the network terminal;
downloading from the auxiliary content database the requested auxiliary content to the network terminal in a format for retention on the network terminal, the downloaded auxiliary content being associated with the primary media content and comprising one of an electronic ticket, an event schedule and auxiliary media content; and
with the processing instructions rendering the received auxiliary content on the virtual terminal.

28. A removable computer-readable medium comprising:
a media partition including primary media content, the primary media content comprising at least one of an audio presentation, a video presentation and a multimedia presentation; and
a program partition including a computer software module carrying processing instructions for a computer and a reference to a remote content server, the processing instructions when executed by the computer causing the computer to:
transmit over a network to the remote content server a reference to the primary media content;
at the computer receive over the network from the remote content server configuration data defining a presentation format for a virtual terminal, and a reference to an auxiliary content database;
render the virtual terminal at the network terminal;
download from the auxiliary content database the requested auxiliary content to the network terminal in a format for retention on the network terminal, the downloaded auxiliary content being associated with the primary media content and comprising one of an electronic ticket, an event schedule and auxiliary media content; and
render the received auxiliary content on the virtual terminal.
